(19) United States
(12) Patent Application Publication
(10) Pub. No.: US 2013/0255413 A1
(43) Pub. Date: Oct. 3, 2013

(54) Stand-along automatic basket lift for fryers

(71) Applicant: Yi Liu, Lincoln, NE (US)

(72) Inventor: Yi Liu, Lincoln, NE (US)

(21) Appl. No.: 13/433,847

(22) Filed: Mar. 29, 2012

(51) Int. Cl. F16H 19/02

(52) U.S. Cl. 74/89.37; 74/89

(57) ABSTRACT

The invention is a stand-alone automatic basket lift for deep fryers. The lift has an arm controlled by a timer. A standard basket 14×5×5 inch containing food is attached to the arm. Upon pushing the start button, the arm will lower the basket into the fryer and stay a predetermined time there frying the food. After the predetermined time elapses, the basket is lifted out of the deep fryer. The timer has six memories to store the predetermined time at user's desire. The predetermined time can be programmed to the accuracy of one second by the user. The maximum predetermined time is 99 minutes and the minimum is one second. Each lift is a stand-alone machine and can be installed at different positions relative to the fryer. For practical applications, two lifts are built into one unit. Three models for different installation positions are designed: side-installation model, back-installation model and top-installation model.

### BACKGROUND

Various basket lifting mechanisms have been provided in deep fat fryers. A forward lower portion mounting of lifting mechanism at fryer casing was invented by Anetsberger et al. (U.S. Pat. No. 4,508,026). Further advancements were made by Prudhomme, U.S. Pat. No 5,469,778) for large quantities of food in larger fryers vertically reciprocated along a guide track. Baillieul et al. invented electric deep fat fryer comprising a vat, cooking bath, an electric heater (U.S. Pat. No 6,138,552). Savage (U.S. Pat. No. 6,588,325) filed a patent on a mechanical assist for raising and lowering food baskets in a deep fat fryer.

### ADVANTAGES OF CURRENT INVENTION

So far, the earlier lifts for fryers are built-in models. Compared with the earlier lifting mechanisms for deep fryers, the current invention is unique because it is a stand-alone unit. The unit has two independent lifts with two lifting arms suitable for lifting two baskets independently. The unit has a small dimension of about two inches in thickness, with height and width suitable for installation in several locations by the fryer or inside the fryer. It has two digital timers to control the two lifts independently. The user can easily change the predetermined time. The system is stable; it will stop safely when the electric power is accidentally cut off and it will reset to a standby position when the power is recovered. It is built to lift food load as heavy as needed.

### BRIEF DESCRIPTION OF THE DRAWINGS

FIG. 1 is a front view of the structure of two lifts in a mechanical unit.

FIG. 2 shows the structure of the linear motion assembly.

FIG. 3 shows the structure of the spring coupler 11, balancing spring 10, linear bearing set 8 and the magnet sealing set 20.

FIG. 4 is a front view of the side-installation model and its installation at the side of the fryer. One new arm sets 22, 23 for this model has been invented.

FIG. 5 is a front view of the back-installation model and its installation at the back of the fryer. One new arm sets 24, 25 for this model has been invented.

FIG. 6 is a front view of the top-installation model and its installation at the top of the fryer. One new arm sets 26 for this model has been invented.

### DETAILED DESCRIPTION

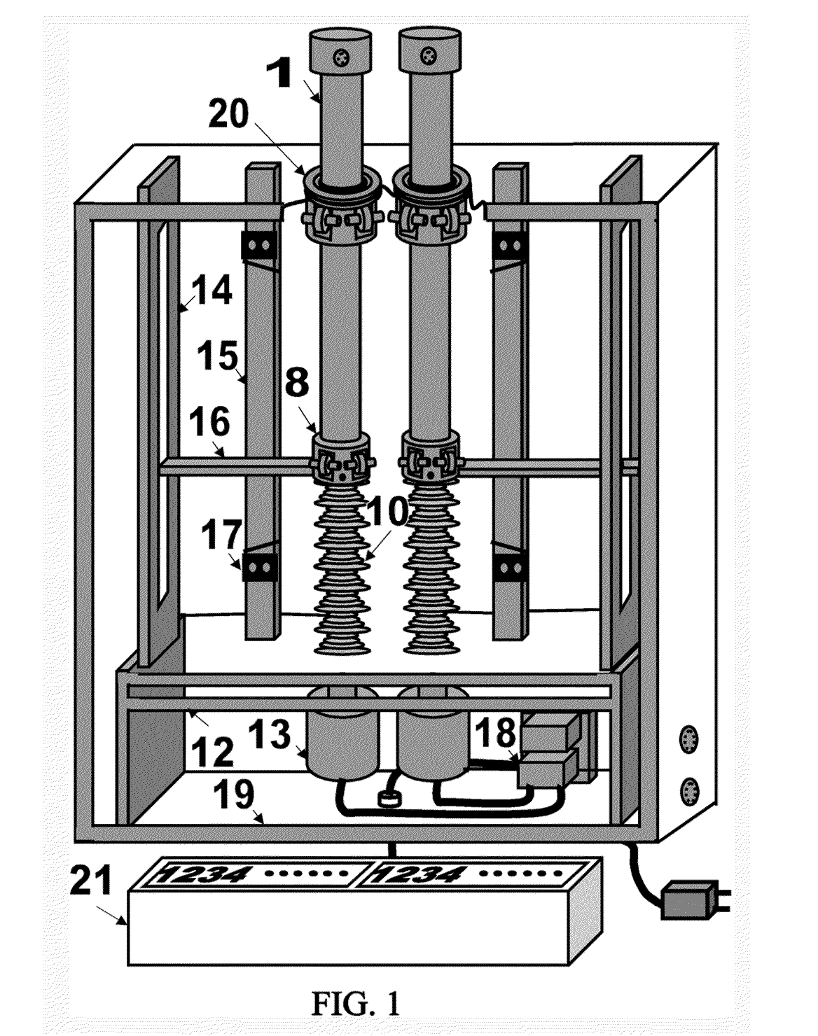

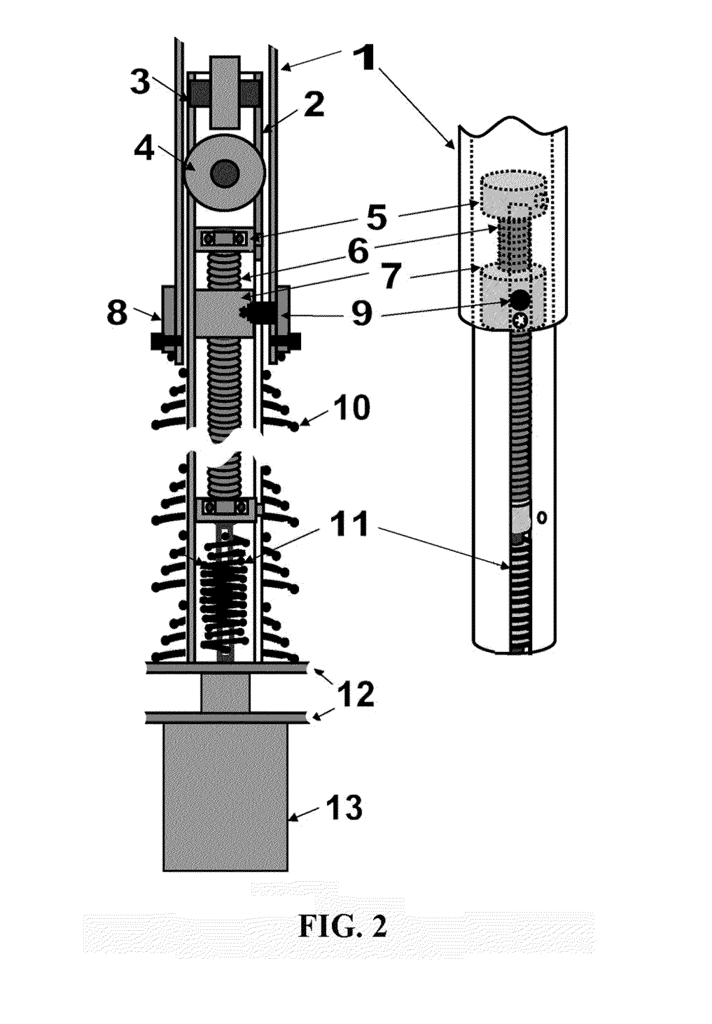

The mechanical unit has two independent lifts controlled by two timers 21. The mechanical parts of the two lifts are mounted in a steel case 19 as shown in FIG. 1. Each lift is composed of a linear motion assembly 1˜13, rotation limiting plates 14,16, position limiting switches 17, a balancing spring 10, and a magnet sealing set 20. The details of the linear motion assembly are shown in FIG. 2. The motor 13 provides the drive for the linear motion when it receives a signal from the timer and the relay circuit. The motor is connected to the screw rod 6 by a spring coupler 11. The screw rod is installed in a steel tube 2 using two rotational bearings 5. The steel tube 2 is welded on plates 12. A slider 7 mounted on the screw rod will move up and down as the motor rotates in a clockwise/counter-clockwise direction. This linear motion is connected to tube 1 by a pin 9 through to rectangular opening on tube 2. The bearings 3 and 4 are mounted on tube 2 and provide the support between tube 1 and tube 2. The four bearings mounted on tube 8 at 90 degrees angle from each other are named linear bearing set which provides the supporting structure at the lower end of tube 1. The tube 8 is fixed on tube 1 by 4 screws. The same linear bearing set of larger size 20 is mounted on the top of the case to provide guidance and reduce friction of tube 1 with the case.

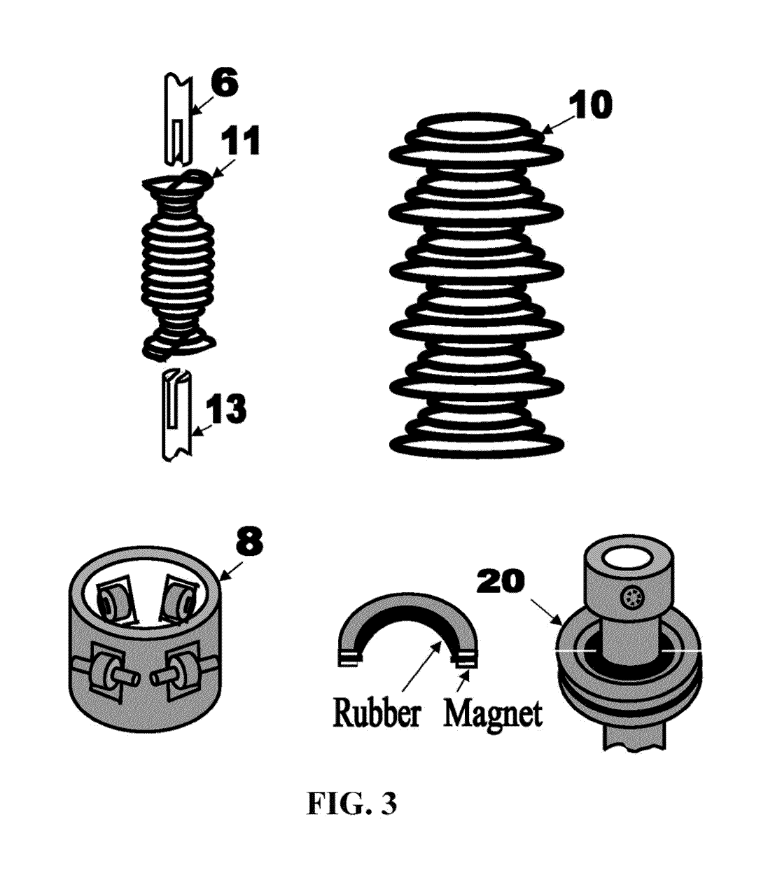

FIG. 3 shows the details of the spring coupler 11, balancing spring 10, linear bearing set 8 and magnet sealing set 20. The spring coupler has both ends bent. A notch is opened at the ends of the screw rod and the shaft of the motor. These notches allow the spring coupler to be mounted on the ends of the screw rod and the shaft of the motor. The advantages of such spring couplers are that it is easy to make, has a low cost and can self lock. Once mounted, it will never come loose due to extended use.

The balancing spring 10 is a varying diameter spring. It can be compressed to a height half of constant diameter spring with the same number of turns.

The linear bearing set 8 has four bearings welded on the steel tube 8. It features a high load capability, low friction.

The magnet sealing set 20 is composed of four half-ring magnets and two pieces of half-ring rubber. The whole set can be easily removed from the unit for cleaning.

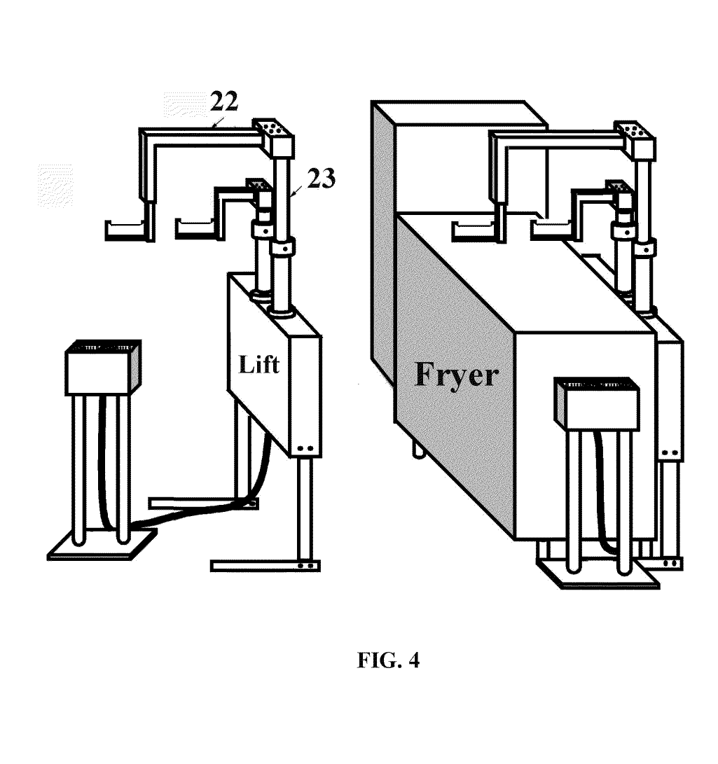

The side-installation model is shown in FIG. 4. The positions of the arm components 22,23 can be adjusted by loosening the screws, and then sliding.

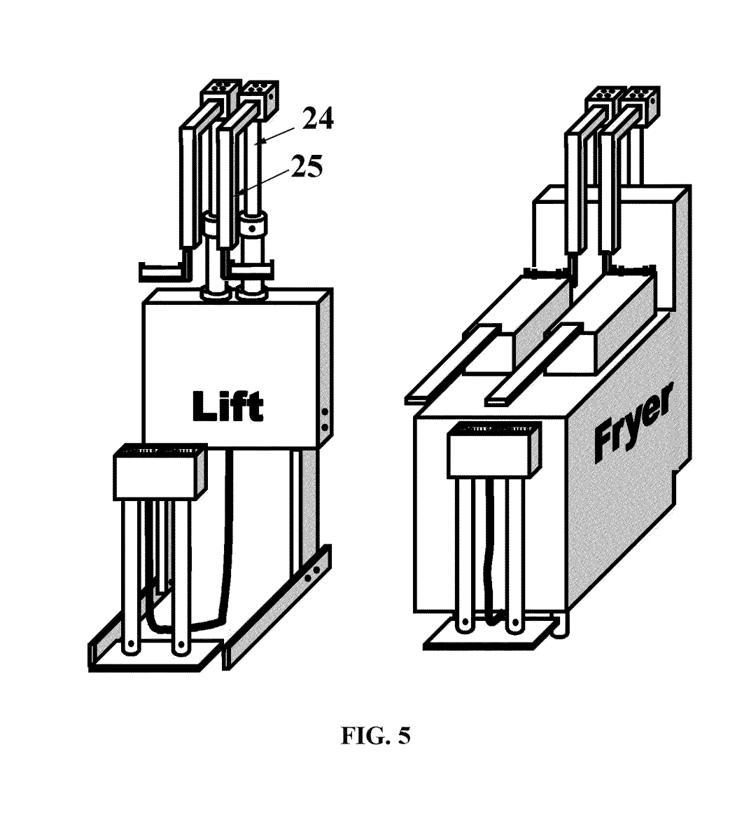

The back-installation model is shown in FIG. 5. The positions of the arm components 24,25 can be adjusted by loosening the screws, and then sliding.

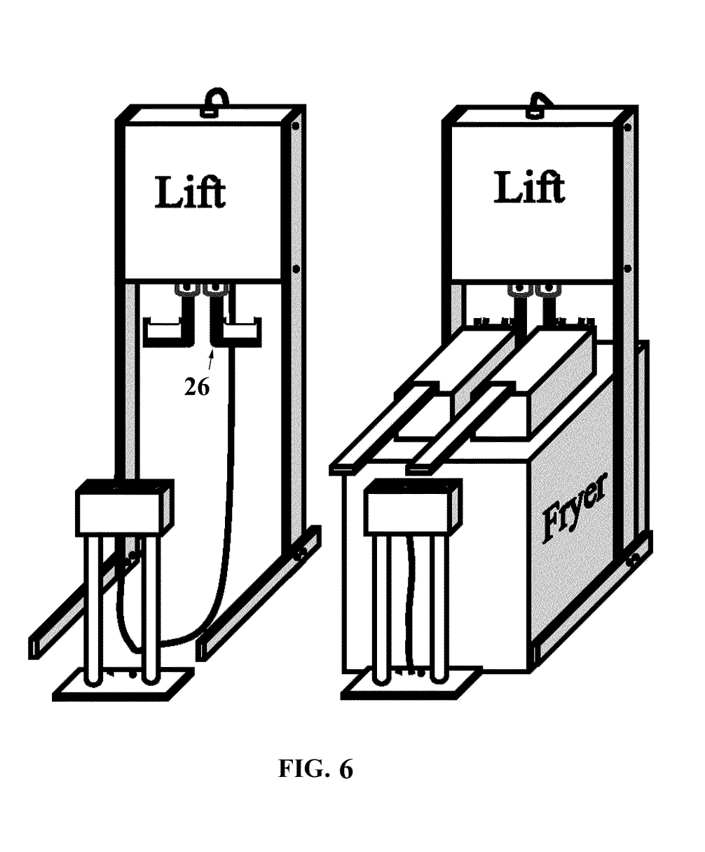

The upper-installation model is shown in FIG. 6. The positions of the arm components 26 can be adjusted by loosening the screws, and then sliding.

### REFERENCES

| | | |
|---|---|---|
| 4,508,026 | April 1985 | Anetsberger et al. |
| 5,469,778 | November 1995 | Prudhomme et al. |
| 6,138,552 | October 2000 | Baillieul et al. |
| 6,588,325 | July 2003 | Savage |
| 7,255,379 | June 2004 | Adams |

1. The linear motion assembly comprising the screw rod 6, slider 7, rotational bearing set 5, co-axis steel tubes 1,2, linear bearing set 8 as shown in FIG. 1 and FIG. 2. This structure provides linear motion vertically and supports a high torque load required in all position installation models shown later.

2. The rotation limiting plates comprising horizontal plate 16 and vertical plate 14 which prevent the tube 1 from rotation.

3. The bottom mounted motor 13 and the supporting plates 12.

4. The spring connector 11.

5. The top and bottom position switches 17.

6. The balancing springs 10.

7. The magnets-rubber sealing structure 20. This structure provides sealing of the steel case and can be removed from the steel case for cleaning.

8. The arms set 22,23 upon which the baskets are put for the side-installation model as shown in FIG. 4. This model provides the easiest installation on the side of the fryer.

9. The arms set 24,25 upon which the baskets are attached for the back-installation model as shown in FIG. 5. This model has the advantage of not occupying hood space in the side.

10. The arm sets 26, 27,28,29 in the heavy-load model as shown in FIG. 6. This model can lift heavy loads, and allow different sizes of trays or baskets. The arm set 26,27, for example, is suitable for frying foods such as donuts. The arm set 28,29, for example, is suitable for cooking pasta. It can be installed on the back or to the side of the fryer.

11. The arms set 30 upon which the baskets are put for the inner-installation model as shown in FIG. 7. This model has a minimum exposed surface making it easier for cleaning.

12. The arms set 31 upon which the baskets are put for the top-installation model as shown in FIG. 8. The balancing spring is installed on tube 1 in this model to balancing the weight. This model has the advantage of requiring no modification of the fryer and does not take space on the side or back of the fryer. It can be used to support plates shown in FIG. 8 or use a fixer to be attached to the fryer.

13. The steel case and its supporting legs, plates as shown in FIGS. 4, 5, 6, 7 and 8. Such supporting legs and plates allow adjustments in height and can be removed from the case for transportation.
